(19) United States
(12) Patent Application Publication
(10) Pub. No.: US 2005/0071310 A1
(43) Pub. Date: Mar. 31, 2005

(54) System, method, and computer program product for identifying multi-page documents in hypertext collections

(76) Inventors: Nadav Eiron, San Jose, CA (US); Kevin Snow McCurley, San Jose, CA (US)

Correspondence Address: Marc D. McSwain;IBM Corporation, Intellectual Property Law C4TA/J2B, 650 Harry Road, San Jose, CA, 95120-6099, US

(21) Appl. No.: 10/676,918

(22) Filed: Sep. 30, 2003

(51) Int. Cl. G06F 7/00

(52) U.S. Cl. 707/1

(57) ABSTRACT

A system, method, and computer program product for identifying compound documents as a coherent body of hyperlinked material on a single topic as created by an author or collaborating authors, analyzing the content and structure of the compound documents and related hyperlinks, and responsively selecting a preferred entry point at which to begin processing such documents. The body of material may include the internet, an intranet, or other digital library that typically has content distributed over several separate pages or URLs, sometimes in a hierarchical directory structure. The processing may include creating at least one taxonomy, as well as searching or indexing the compound documents. The identification and analysis schemes include a observation of a number of heuristics run on component documents in the compound documents.

### FIELD OF THE INVENTION

This invention relates to retrieving, analyzing, and organizing information from a hyperlinked collection of documents. Specifically, the invention identifies compound documents as a coherent body of hyperlinked material on a single topic by an author or group of collaborating authors, and analyzes the content and structure of the compound documents and related hyperlinks to select a preferred entry point for processing such documents.

### BACKGROUND OF THE INVENTION

The rapid growth and sheer size of the World Wide Web has given prominence to the problem of being “lost in hypertext”, and has thereby fueled interest in problems of web information retrieval. In many ways, the invention of hypertext can be seen in a historical context alongside the invention of tables of contents and inverted indices for books (both of which date back to at least the 18th century). Hyperlinks can be seen as a natural evolution and refinement of the notion of literary citations in written scientific material, because they provide a means in which to place information units (e.g., books or articles) into a larger body of information. A table of contents, index, or citation in written text can each be seen as being designed to facilitate a particular mode of access to information, and the choice of one structure or another is dictated by the nature of the media as well as the information content.

One often cited feature that distinguishes hypertext from other forms of textual material is the degree to which “nonlinear access” is embraced as a goal. Printed documents vary quite a bit in the degree of linearity they exhibit. At one extreme we have novels, which are generally intended to be read front to back, and are structured along these lines. By contrast, a dictionary is specifically designed to be read in an entirely non-linear fashion, and the visual layout of a dictionary is specifically tailored to facilitate this form of usage. In between these extremes we see reference materials (e.g., encyclopedias or reference manuals) with strongly hierarchical organization, with an elaborate table of contents and inverted index to facilitate nonlinear access, but individual units of information (e.g., sections and or chapters) that are designed to be accessed linearly.

Just as in printed documents, there is a corresponding spectrum of information organization and intended access present on the World Wide Web. Hypertext is generally thought of as a collection of nodes and links, wherein the reader may traverse the links between nodes, digesting information as they go. One feature that seems evident in the World Wide Web is that there is often a higher layer of abstraction for “information units” than hypertext nodes (or URLs), namely the notion of a “document”, i.e. individual nodes on the World Wide Web tend to have a much smaller granularity than text documents. Conventional information retrieval techniques are better suited to working on documents than individual hypertext nodes.

Documents are typically authored by a single author, or in the case where there are multiple authors, the coauthors should at least be aware of each other's contributions to the document. Examples include manuals, articles in a newspaper or magazine, or an entire book. One might also expand the definition to include threads of discussions by multiple authors on a single topic, in which case authors that begin the discussion may not remain aware of the contributions made by later authors. The concept of a “document” is perhaps ambiguous, but in this application the specific term “compound document” means a coherent body of material on a single topic, by an author or group of collaborating authors, deployed as a collection of hyperlinked documents.

An example is provided by a recent article on the SemanticWeb by Berners-Lee et al. [3] that appeared both in print and on the web. This article is written in the theme of a widely accessible research survey article, and as such is primarily intended to be read linearly. In spite of this, the primary web version has been split into eight sections consisting of eight different URLs, each with hyperlinks to the other seven sections as well as links to the previous section, the next section, and a “printer-friendly” version that contains the HTML within the content at a single URL. The deployment of this article onto the web provides a good example of the dissimilarity of the notion of “document” and URL.

There are numerous reasons why documents are often split across multiple nodes. In the early days of the web, documents were generally synonymous with single HTML files that were retrieved via HTTP. As HTML and tools to produce it evolved, it became common for authors to exploit the power of hypertext, by producing documents whose sections are split across multiple URLs. Early examples of compound documents on the web were constructed as framesets, but it is now more popular to author documents as multiple independent URLs, with hyperlinks to navigate through the document. HTML documents consist of text as well as numerous other content types, including embedded multimedia and style sheets. Moreover, the concept of compound documents is a feature of hypertext, and may exist in other forms such as XML.

In addition to the navigational benefit for splitting documents across multiple URLs, there are other good reasons. For example, documents may be split into multiple pieces in order to optimize the use of available communication bandwidth. They may also be split into separate pieces in order to facilitate multiple authorship. Traditional newspaper publishing has had a long-standing tradition of beginning an article on one page and continuing on another in order to optimize the placement and exposure of advertising. The same principle has been carried over to web news sites, in which an article is broken across multiple URLs to display a new set of ads when the reader loads each page.

In a distributed hypertext environment such as the world wide web, there are many different points of view, many different authors, and many different motivations for presenting information. The information in such an environment is often contentious, and a proper understanding of information can only be made when it is placed in the context of the origin and motivation for the information. Thus, the identification of authorship boundaries can be an important aspect of the World Wide Web. Examples where this is particularly important include the presentation of scientific information, business information, and political information.

This problem becomes particularly acute in the application of information retrieval techniques such as classification and text search to the web. Most techniques from information retrieval have been designed to apply to collections of complete documents rather than document fragments. For example, attempts to classify documents according to their term frequency distributions or overall structure of section headings will be less effective when applied to document fragments. Inferences made from co-citation [15] and bibliographic coupling [8] will also be less informative when they are applied to document fragments rather than documents. If the hyperlinks from a document occur in separate sections represented by separate URLs, then these co-citations may be obscured. The same is true for co-occurrence of concepts or people [2].

There are disadvantages to distributing material over multiple linked pages. Two commonly cited measures of success in information retrieval are precision and recall, both of which are adversely impacted by the fragmentation of documents into small pieces. Documents that are broken into multiple URLs present a problem for complex queries, because the multiple terms may appear in different parts of the document, so returning a precise query answer is difficult. While it may be useful to be able to pinpoint occurrences of query terms within a subsection of a document, text indexing systems cannot retrieve entire documents that satisfy the query from across all their pieces.

This improvement in recall also holds promise to improve the precision of search engines. Whenever a user interacts with a system, they tend to learn what works and what does not. By indexing small units of information as individual documents, users are discouraged from using complex queries in their search, as it may result in the exclusion of relevant documents from the results. Thus the recall problem arising from indexing subdocuments inhibits users from specifying their information needs precisely, and thereby interferes with the precision of the search engine. Several studies on web query logs [13, 17] suggest that users often use very simple queries consisting of one or two terms. Part of reason underlying such naive queries may be that specifying more terms will tend to reduce the recall in current search engines. A system that encourages users to use more specific complex queries will probably improve the precision of match to their intended information task.

Whether a compound document is “linear” or not, it will still generally have at least one URL that is distinguished as an entry point or “leader”. For documents that are intended to be read linearly, this is often a table of contents or title page. For other documents, it consists of the page that readers are intended to see first, or the URL that is identified for external linking purposes. When a compound document is placed on a web site, a hyperlink is generally created to this entry point, although there is nothing to prevent hyperlinks to internal parts of the compound document and they are often created when a specific part of the document is referenced externally. Identifying these entry points for compound documents is very important.

There has been previous work in this field. Tajima et al. [23] identify the problem of organizing multiple URLs into documents, but their primary technique for identifying when documents should be grouped together is through similarity of term frequencies in the text. This is a very expensive operation that does not scale well to the web.

The concept of an entry point or leader is related to work by Mizuuchi et al. [10] in which the authors identify “context paths” for web pages. Their goal was to identify the path by which the author intended that a web page would be entered, so as to establish context for the content of the page. They discuss improving search results by identifying, among all in-links into a page, the in-link that the author meant for the reader to use to enter the page, and enhance the tokens indexed for the page with some information (anchor text, title, etc.) from the pointing page. Their work mentions the hierarchical nature of the web, as well as the fact that authors expect users to read through more than one of their web pages. However, they consider every page individually. Their technique seems to primarily be an extension of anchor text indexing, where they use information from the entry point to an individual page to provide indexing information about the page. Their techniques have some overlap with the identification of “leaders”, but they use them to solve a different problem.

Flake et al. [22] use a notion of identifying sets of URLs as a “community” when they have more links within the community than outside the community. This paper gives at least one example of identifying a connection between web pages based on commonality between the links from these pages, but again the organization is by topic rather than by document.

Website www.google.com shows a single web page from a site as an answer to the query, and groups other pages on the same site as an indented list. This does not help in improving recall, but performs a grouping of pages on the same site that are all found to contain the same terms.

Website www.kartoo.com presents another organization of information-centered around sites rather than individual web pages, but does not appear to address the recall question and does not identify documents.

Adamic [30] identifies that pages on a site that satisfy a given query usually happen to form a tightly linked subgraph of the overall web. The author suggests a strategy for improving the results of a web search engine by grouping the pages satisfying a query into strongly connected components, finding the largest strongly connected component, finding a “center” of this component, and further steps to refine the query. This recognizes that pages on a topic are connected to each other. This is evidently related to the method implemented by google for displaying the hits on a site grouped together, but once again organizes URLs by topic rather than identifies documents.

The existence of compound documents in the web has been identified previously. Even prior to the invention of the world wide web, Botafogo et al. [4] identified hypertext aggregates from the structure of the hyperlink graph in hypertext. In [20], Weiss et al. addressed the problem of dynamically identifying and returning compound document clusters as answers to queries in a search engine. In [18], Tajima et al. identify the problem of organizing multiple URLs into clusters, and they suggested a dynamic approach to resolving multi-term queries by expanding the graph from individual pages that contain the query terms.

There is no simple formulation of a single technique that will identify compound documents. Recognizing and grouping hypertext nodes into cohesive documents, including identifying entry points and the full extent of compound documents, can play an important role in future web information retrieval, analysis, and organization. A method for reconstructing compound documents based on discerning clues about the document authoring process, or by structural relationships between URLs and their content, is therefore needed.

### SUMMARY OF THE INVENTION

It is accordingly an object of this invention to provide a system, method, and computer program product for retrieving, analyzing, and organizing information from a hyperlinked collection of materials. The internet, an intranet, and other digital libraries are examples of such hyperlinked collections, in which content is distributed over a plurality of URLs (Universal Resource Locators).

In a preferred embodiment, the invention identifies a compound document as a coherent body of hyperlinked material on a single topic by an author or group of collaborating authors. The invention then analyzes the content and structure of the compound document and related hyperlinks to find a preferred entry point, and then processes the compound document from the entry point. The processing can include creating at least one taxonomy, searching, and indexing.

By organizing multiple URLs to more accurately represent the definition of a “document”, the invention provides a better notion of a retrievable unit of information for a search engine, and is thus a better quality tool for information retrieval. It presents a list of documents to the user rather than a list of URLs, which is a more compact and better organized list of information sources.

The invention can identify the compound document by running a number of heuristics on the hyperlinked materials, where each heuristic is designed to detect various features of compound documents. Parameters can be specified for the heuristics, to adjust the likelihood of correctly identifying (and not mis-identifying) compound documents. The heuristics preferably go through web pages in directory order; looking only at pages within the same or neighboring directories helps keep the computation feasible. If any particular heuristic determines that a combination of hyperlinked materials forms a compound document, then the invention deems that combination to be a compound document.

One heuristic for identifying a compound document uses hints from-anchor text to identify linguistic conventions in anchor text that indicate a relationship between different URLs in a compound document. Examples include the use of the term “next” or “previous” in anchor text. Another heuristic for identifying a compound document, termed the “anchor text heuristic”, is to look for directories that have a sufficiently large percentage of URLs within them that have a sufficient quantity of shared anchor text to other URLs in the directories.

A further heuristic, termed the “rare link heuristic”, includes identifying a compound document by detecting a number of external hyperlinks that mostly point to the same place. Another heuristic identifies compound documents by identifying similar dates of creation or dates of most recent modification or dates of expiration. A different heuristic identifies individual URLs having similar structure indicating an order of inclusion in the compound document. An additional heuristic identifies a link structure of an often-bidirectional “wheel” form, wherein the hub is typically a table of contents linked to different sections of the document, where the different individual sections are often linked to previous and subsequent sections as well as to the hub.

The invention then analyzes the content and structure of the compound document and related hyperlinks to find the preferred entry point. The analysis includes running a number of heuristics on the compound document, where each heuristic is designed to detect various features of compound documents that indicate a good entry point. The entry point is suitable for presentation to a user as a representative URL for the compound document. One such heuristic is to identify specific filenames that authors often intend to define the entry point, such as “index” and “default” or non-English equivalents. Another heuristic is to identify a component document in the compound document that has a large number of in-links, for example to a table of contents page. The in-links may all be from within the same directory structure, or may be from outside the compound document (e.g. from external sites). Another related heuristic is to identify a component document in the compound document that has a large number of out-links, for example from a table of contents page to other pages within the same directory structure.

A different analysis heuristic is to measure the vector of distances along intra-document links between a specific component document and all other component documents in a compound document and then find the node for which this vector has minimal norm. Another heuristic is to determine whether a URL has links pointing to longer URLs (xyz.com/subnode1.htm and xyz.com/subnode2.htm) that have identical root components (xyz.com) but then have additional ending directory components. A further related heuristic involves examining the ending directory components for specific information, such as a page number or article number (xyz.com/article?id=12345&page=678).

The foregoing objects are believed to be satisfied by the embodiments of the present invention as described below. Experimental data is also provided.

### BRIEF DESCRIPTION OF THE DRAWINGS

FIG. 1 is a graph that depicts the fraction of nodes in a directory that are contained in the largest SCC (strongly connected component).

FIG. 2 is a graph that depicts the fraction of nodes in the directory that are contained in the largest reachable component.

FIG. 3 is a graph that depicts the number of directories in a test corpus that have a certain value of β, for α=0.5.

FIG. 4 is a graph that depicts the number of directories that have a certain value of α on a subset of the corpus.

FIG. 5 is a diagram of a typically bidirectional wheel linkage structure.

### DETAILED DESCRIPTION OF THE INVENTION

This invention provides a method for identifying “documents” that consist of the content from multiple web pages. We use the term “document” to refer to the traditional notion of a cohesive article by an author or group of collaborating authors that one might read in a newspaper, magazine, or book. In today's web it is commonplace to have a document broken across multiple URLs, but most information processing tools for tasks such as indexing and taxonomy generation assume that they are working on entire documents. We propose a method to discover documents on the web, which means that we identify sets of URLs and an entry point to this set of URLs. This has the potential to dramatically improve information processing tasks on the web or intranets.

There are numerous examples of scenarios in which a “document” is broken into multiple URLs when it is presented on the web, forming a compound document. Newspaper articles are often broken into multiple pages in order to show a reader a fresh set of ads when they visit the multiple pages. Thus when reaching the bottom of a web page one may see a link to the “next” page of the document. Some documents consist of multiple sections, with section heads used to assist in navigation; prime examples are manuals or product documentation. Presentations originally written in Microsoft Powerpoint™ or Lotus Freelance Graphics™ are often saved as multiple HTML files to preserve the sequential nature of a presentation; other document converters such as latex2html and DocBook produce similar structures that span multiple web pages. Also, discussion groups collect postings by multiple people on a single subject.

Unfortunately, systems that try to organize hypertext documents in other ways (e.g., in a taxonomy, classifier, or text indexer) now see a view of information as a collection of URLs leading to web pages rather than as a collection of documents. Textual analysis on web documents tends to work at the URL level rather than the document level. For example, term frequencies will be computed on subsections of an entire document rather than the document itself. Documents that contain multiple terms in different sections may not even be retrievable by a search engine because the search engine treats the sections as two separate documents.

The problem of identifying compound documents from their fragments is in some ways similar to the task of clustering related documents together. While document clustering seeks to group information units together according to their content characteristics, this invention seeks to group information units together according to the intent of the original author(s), as it is expressed in the overall hypertext content and structure.

Web search engines allow a user to enter a query consisting perhaps of several words and find all URLs of web pages that contain the query terms. Thus a user who seeks to obtain information about a given topic can supply terms that are unique to that topic, and find documents that contain those terms. In this way search engines serve as information exploration tools. Variations on this basic theme might allow the query to consist of a boolean combination of terms (e.g., to exclude certain terms from the retrieved documents), or insist that the query terms occur in a phrase, or allow synonyms of the query terms to occur in the document, or stemmed versions of the query terms. In addition to returning the URLs of documents that satisfy the query, the search engine may also return additional information about the documents specified by the URLs, including the context in which the terms appear, or a list of duplicate document URLs, or a “relevance” score, or similar guidance to the user to judge which URL to load and read in pursuit of their information search. A search engine may also provide the user the ability to explore for “similar” documents to the returned documents, in the hope that these documents would have a similar topic. While the present invention has primarily been applied to web search engines, it is applicable to any text analysis system (e.g., a classifier or taxonomy generator, as are known in the art).

By grouping URLs together to form cohesive documents, we can accomplish three things. First we reduce the number of overall documents to be analyzed, which can help with complexity of many algorithms. Second, we improve the quality of analysis by forming more representative expressions of human thought. Third, we improve the user experience of a system by organizing data into more natural units and thereby reducing the number of essentially duplicate documents.

A simple and necessary condition for a document arises from thinking of the set of URLs as a directed graph. In order for a set of URLs to be considered as a candidate for a compound document, the set should at least contain a tree embedded within the document (the descendants of the leader). In other words, all parts of the document should be reachable from at least one URL in the document. This weak condition is certainly not enough to declare that a set of URLs forms a compound document, but it provides a fundamental principle to concentrate our attention. In general, most compound documents have even stronger connections between their individual URLs, which reflects the generally accepted hypertext design principle that a reader should always “have a place to go” within a document. As a result, most compound document hyperlink graphs are either strongly connected or nearly so (a directed graph is strongly connected if there is a path from every vertex to every other vertex).

Another fundamental principle used in the invention is reflected in the hierarchical nature of the “path” component of URLs. In the early days of the web, and indeed for many systems today, the part of the URL following the hostname and port is often mapped to a file within a filesystem, and many URLs correspond to files. The hierarchical organization of information within the filesystem was therefore reflected in the structure of URLs from that server. In particular, the tendency of people to use filesystems to collect together files that are related to each other into a single directory shows up in the hierarchical organization of URLs.

This tendency to organize information hierarchically is fundamental in the document authoring process. The hierarchical structure of information within a computer filesystem goes back to the time of the Multics operating system [7] in 1965. In fact, the human process of organizing information hierarchically is even more fundamental than this, since we can trace it back to the time when books were printed with section headings and a table of contents.

The invention can identify compound documents spanning multiple URLs by analysis of the links between URLs and the hierarchical structure of URLs. There are multiple techniques by which such compound documents may be located. People tend to organize parts of a given document in a single directory. Thus all URLs for a book on a product might appear in a directory http://hostname/software/data/. In other cases the parts of the document might lie in different directories, but they will at least be close in the directory hierarchy. For example the table of contents might appear in http://hostname/software/data/toc.html and the individual sections appear in the directory http://hostname/software/data/contents/.

The invention is also designed to determine whether a given directory contains pages that make up a single compound document. It should be noted that while many web servers store pages in hierarchical file systems that use directories and reflect this organization through the URLs that may be retrieved from them, the same techniques often apply to content management systems that store their data in back end databases rather than actual file systems. This is due to the fact that the hierarchical nature of the “path” part of URLs is still used to organize information. To quote from RFC 2396 on URL format: “URL that are hierarchical in nature use the slash “/” character for separating hierarchical components.” Thus it should not be surprising that the individual URLs of a compound document often agree up to the last slash character “/”. In cases of extremely complicated documents (e.g., the Apache™ webserver manual), the internal organization of the document may be reflected in multiple layers of the directory structure in the underlying filesystem, but we have observed that it is rather rare for the URLs of a compound document to differ by more than a single directory component.

This hierarchical organization of information in hypertext has some controversial history to it. In the article that is credited by many for laying the foundations for hypertext, Vannevar Bush [5] claimed that hierarchical organization of information is unnatural:
When data of any sort are placed in storage, they are led alphabetically or numerically, and information is found (when it is) by tracing it down from subclass to subclass . . . The human mind does not work that way. It operates by association.

Ted Nelson has also argued [11] that the hierarchical organization of documents is unnatural, and it “should not be part of the mental structure of documents”. His definition of hypertext was partially designed to improve on what he regarded as a rigid structure imposed by hierarchical filesystems, but it is precisely this hierarchical organization of information that helps the invention recover the original intent of authors.

Whatever view one holds about the applicability of hierarchy in information architecture, there is clear evidence that authors often organize some documents this way. The question is not to choose between hierarchical organization or a at hypertext structure for information. Both have important uses for organization and presentation of information, and the implicit layering of a URL hierarchy upon the hypertext navigational structure has provided important clues to discover the intent of authors in encapsulating their documents.

Compound documents are generally created either by deliberate human authorship of hypertext, or more likely as a result of a translation from another document format, or as output of web content management systems. Examples of compound documents that are generated by various software tools are widespread on the web. Some of the tools that produce such documents include Javadoc documentation, latex2html, Microsoft Powerpoint™, Lotus Freelance™, WebWorks Publisher™, DocBook, Adobe Framemaker™, PIPER and GNU info files.

In recent years an increasing amount of web content is generated by “content management systems”. Examples of content management systems that often produce compound documents include Stellent Outside In™, Vignette Story-Server, FileNET Panagon Lotus Domino™, and Eprise™. The textual content presented by such systems may reside in a storage subsystem other than a filesystem, and therefore may not expose the hierarchical layout of an underlying filesystem in their URLs. In spite of this, the hierarchical organization of information remains an important aspect of how people organize and present their documents, and it is extremely common to see the organization of documents reflected in the hierarchy of URLs used to retrieve them. There are however a minority of sites whose content management systems present different pages of the same compound document using different arguments to a dynamic URL. In this case we can sometimes still see the hierarchy in the URL, e.g., www.xyz.com/article?id=12345&page=678.

One approach to identifying compound documents is to try and recognize the structural hints that are produced by each of these document production systems, and essentially reverse engineer the structure of the original document. For example, Microsoft Powerpoint™ can be used to export a presentation file to a set of HTML documents that represent a compound document. These machine-produced files contain signatures of the tool that produced them, and it is relatively straightforward to recognize these files and reconstruct the compound document. The biggest drawback to this approach is that there are literally dozens of tools, and there are no commonly followed standards for indicating the original relationship between HTML documents. Further problems arise from documents that are authored without the use of such tools, and the constant change in tool output formats as newer version of the tools become available.

Rather than focusing on the nuances of particular document production tools, we have identified a set of characteristics that can be used to identify compound documents independent of their production method. In each case below, we identify a characteristic that compound documents tend to have, and evaluate a heuristic designed to detect that characteristic, but since there are exceptions to each rule it is useful to employ multiple heuristics to reduce the number of false positive identifications. It is hoped that by adopting this approach the invention will remain viable going forward even as tools for producing ever more complicated documents evolve, and as new standards for HTML, XML, or other hypertext formats emerge.

Because the techniques of the invention consist of heuristics, they may fail in a variety of ways. For example, they may fail to identify a compound document when it exists, and we may falsely identify a collection of URLs as a compound document when in fact it is not. The latter situation is more serious, since it may introduce new artifacts into text analysis and retrieval systems that use the technique. In practice, the invention very rarely incorrectly identify a set of URLs as a compound document. The problem of failing to recognize compound documents is avoided by introducing a set of independent heuristics, each of which is able to identify a different set of compound document properties and trigger a conclusion that a compound document has been found. By applying several relatively non-overlapping heuristics, the invention is able to identify all compound documents in a collection with very high success rates.

Another approach that may be used for identification of compound documents would be to use machine learning techniques to build a classifier that will automatically learn the structures that identify compound documents. While we have not experimented with this approach, primarily for the lack of training data, we believe our techniques may be useful in this context as well. Some of our techniques require parameter tuning that may be done automatically. Furthermore, in many machine learning problems, identification of the features to be used for learning is one of the most crucial ingredient for the success of the learning process. While the description focuses on rather direct heuristics or rules for identification of compound documents, the same features used here are good candidates to be used in a machine learning framework for the same problem.

Experimental Methodology

Our observations are based on experience with three data sets. The first of these is IBM's intranet, from which we crawled approximately 20 million URLs. This intranet is extremely heterogeneous, being deployed with at least 50 different varieties of web servers, using a wide variety of content formats, content preparation tools, and languages. Aside from the obvious content differences, this large intranet appears to mirror the commercial part of the web in many ways, but we had doubts that our observations of such a large intranet would differ substantially from the web. (One reason for concern is the tendency to use Lotus Domino™ web servers within IBM, but these are easily identified and were not a major factor in our conclusions). In order to address these concerns, we examined a second data set of 219 million pages crawled from the web at large in late 2001. However, it turned out that this data set triggered many false identifications of compound documents, which we have not seen on the IBM intranet data. We believe this is the result of that crawl being incomplete: Since our crawler approximates follows a BFS algorithm, a partial crawl (one that was stopped before a significant fraction of the web was crawled) would tend to only find the most linked-to URLs in each host or directory. This makes directories appear to be smaller and better connected than they really are.

In order to address these concerns, we re-crawled a random subset of 50,000 hosts from those that showed up in the big crawl. This crawl was run until almost no new URLs were being discovered. This data set turned out to be very similar to the IBM intranet dataset in terms of the numbers and types of compound documents it contained.

Exploiting Link Structure

Hyperlinks tend to be created for multiple reasons, including both intradocument navigation and interdocument navigation. In practice it is often possible to discern the nature of a link from structural features of HTML documents. One way of doing so is to consider the relative position of source and destination URLs in the hierarchy of URLs. This connection has previously been mentioned by multiple authors [10, 16, 18] as a means to categorize links. Using this factor, hyperlinks may be broken down into one of five categories:
Outside links=connect a page on one website to a link on another website.
Across links=connect a page on one website to a page on the same website that is neither above nor below the source in the directory hierarchy.
Down links=connect a page to a page below it in the directory hierarchy.
Up links=connect a page to a page above it in the directory hierarchy.
Inside links=connect a page to a page within the same directory.

Each of these link types holds a potential clue for identification of a compound document. Inside links form the bulk of links between the sections of a compound document, although not every inside link is a link between two parts of a compound document. Outside and Across links are more likely to go to leaders in a compound document than a random component of a compound document, but are seldom between two separate parts of the same compound document. Down and Up links are somewhat more likely to go between two pieces of a compound document, but if so then they tend to form the links between individual sections and a table of contents or index for the document.

A necessary condition for a set of URLs to form a compound document is that their link graph should contain a vertex that has a path to every other part of the document. More precisely, compound documents are commonly found to contain at least one of the following graph structures within their hyperlink graph:

Linear paths—A path is characterized by the fact that there is a single ordered path through the document, and navigation to other parts of the document are usually secondary. These are very common among news sites, in which the reader will encounter a “next page” link at the bottom of each page. They are also common in tutorials and exams that seek to pace the reader. The links may or may not be bidirectional.

Fully connected—Fully connected graphs are typical of some news publications or relatively short technical documents and presentations. These type of documents have on each page links to all other pages of the document (typically numbered by the destination page number).

Wheel Documents—These documents that contain a table of contents have links from this single table of contents to the individual sections of the document. The table of contents then forms a kind of “hub” for the document, with spokes leading out to the individual sections. Once again the links may or may not be bidirectional.

Multi-level documents—Extremely complex documents may contain irregular link structures such as multilevel table of contents. Another example occurs in online archives of mailing lists that are organized by thread, in which multiple messages on the same topic are linearly organized as threads within the overall list of messages.

Clearly these characterizations are not disjoint, and the existence of such a link structure between a set of URLs does not indicate that a compound document is present. We now present specific features that eliminate false positives from these characteristics.

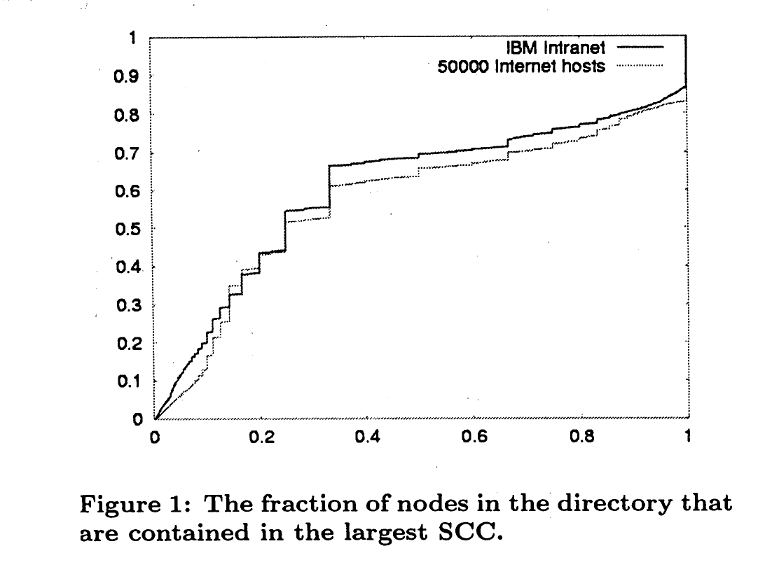

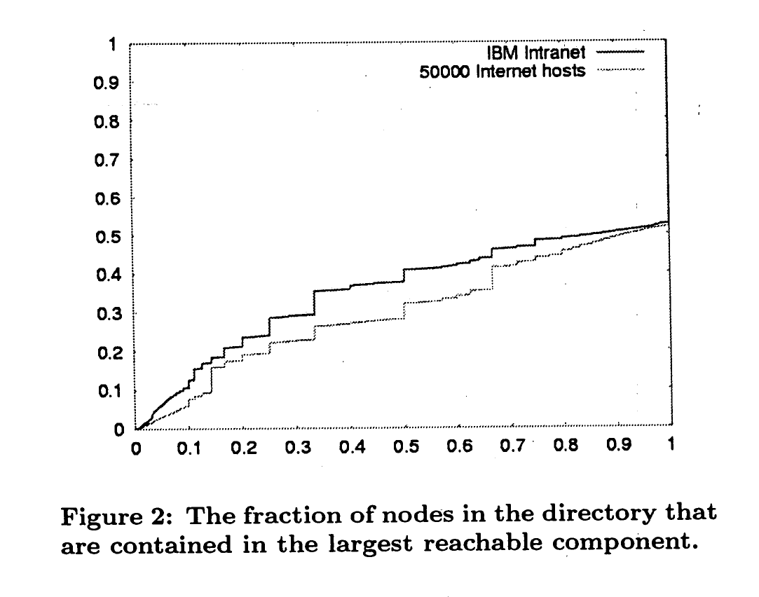

Typically, when all pages in a directory on a web server are written as part of a single body of text, inside (i.e., intradirectory) links will tend to allow the reader to navigate between all parts of the document. Conversely, directories in which one needs to follow links that go outside the directory to get from one page to another are bad candidates for compound documents. However, in the real world, this observation is not significant enough feature to be useful as a primary heuristic for identifying compound documents. Furthermore, this heuristic presents both false-negative and false-positive errors. The main reasons for the inadequacy of this method are the following:
Strong connectivity is too restrictive; in many cases, a compound document will not be strongly connected. There could be many causes for this phenomenon: Certain documents are meant to be read sequentially, and do not provide back-links, in other cases certain URLs are used in a frames setting where navigation is carried out by using links on other URLs that appear in their own “navigation frame”. Overall, we have found that while the majority of compound documents have a sizeable subset of their pages within a single strongly connected component (SCC), not very many have all pages in one SCC. See FIG. 1, which depicts the fraction of nodes in the directory that are contained in the largest SCC.
Reachability is not restrictive enough: As can be seen in FIG. 2, which depicts the fraction of nodes in the directory that are contained in the largest reachable component, more than half of the directories in our test corpus have all URLs within the directory reachable from at least some URL in the directory. This basically reinforces the intuition that people put multiple files into a single directory because there is some relationship between those files. However, the affinity between the pages, many times, will be too weak for the directory to be regarded as a single coherent document.
In some cases, while a single directory may indeed contain all of the content for a compound document, some of the navigation structure may be outside of that directory. The classical example is the case where the table of content for a document is one directory above the content itself (and is the only page from the document that is outside the directory). In this case, the directory containing the content may appear to have multiple disconnected components (one per section of the document, perhaps), when all external links are removed. Still, for indexing purposes, most of the information about the document is indeed contained in that one directory.
   The Rare Links Heuristic

The Rare Links Heuristic is based on the assumption that since a compound document deals with a well defined subject, and was written by a single author over a relatively short time period, links from different parts of the document to external documents will be similar (in practice, many of these links are the result of templated links inserted by the formatting software used to generate the document). Therefore, a directory on a web server in which nearly all pages have the same set of outbound external links is likely to be a compound document.

Directories in which most external links (links leaving the directory) are “templated”, i.e. most pages have the same (or similar) external links coming out of them (if they have any such links at all). Compound documents contain either very few human-authored hyperlinks that are not part of the navigational structure of the document itself (as is usually the case with a compound document that was generated from a single source document by some format converter, such as the Microsoft Powerpoint™ “save as HTML” option), or contains multiple pages that were manually authored by the same human author (or small group of authors) during a short period of time. In the first case, any external hyperlinks found in the document are likely to have been generated by the format translation software, and as such will have a regular pattern to them (in most cases, links will be identical in all pages, except perhaps for pages like a TOC or an index). In the second case, the links are indicative of the subject (including author bias towards the subject) of the page. Since the same author typically wrote all pages, and the pages share a common subject, they will tend to have links to the same places.

The heuristic is applied to one directory at a time. Again, two URLs are considered to belong to the same directory if they match (as strings) up to the rightmost “/” character. The algorithm uses two parameters α and β, and works as follows. Define the set E to be the set of all external links, i.e., links (v1, v2) where v2 is not in the current directory (this encompasses Outside, Across, Up and Down links). Let n be the number of-URLs in the current directory. Define the set R of rare links to be:
R={(v1, v2): (v1, v2)εEΛ|{v: (v,v2)εE}|<αn}

According to the rare links heuristic, we label the directory as comprising a compound document if |R|<<(1−β)|E|. The parameter α determines our definition of what constitutes a “rare link”. The parameter β is the fraction of the external links that are required to be common (i.e., not rare) for the directory to be considered a compound document.

The Common Anchor Text Heuristic

One of the clear indications of at least some compound documents is the presence of templated navigational links within the compound document. These links are typically within the same directory, and have similar anchor text in a large percentage of the pages in that directory. Such links may take the form of “next” and “previous” links in linearly connected graphs, “TOC” and “Index” links in wheel-type graphs, and links with numbered pages (e.g. 1 2 3 4) in full-connected graphs. We use this trait of many compound documents by identifying directories where a large percentage of pages have at least two intra-directory out-links with fixed anchor text. This allows us to identify these templated navigational links without using any tool specific or even language specific information.

Like the Rare Link Heuristic, the Common Anchor Text Heuristic works on a directory at a time. We consider only the internal links (i.e., links where both the source and destination are in the current directory). The directory is flagged as a compound document by this heuristic if there exist two anchor texts α₁ and α₂, such that at least an α fraction of the files within the directory have at least one outgoing internal link that has anchor text α₁, and one outgoing internal link that has anchor text α₂.

Order of Inclusion/Date Information

For both manually authored compound documents and for compound documents that are created by a document translation system, the individual URLs tend to have a very similar structure that indicates their order of inclusion in the document. Thus if we see URLs ch1.htm ch2.htm ch3.htm in the same directory, it is often the case that these represent sections of a compound document.

Link Structure

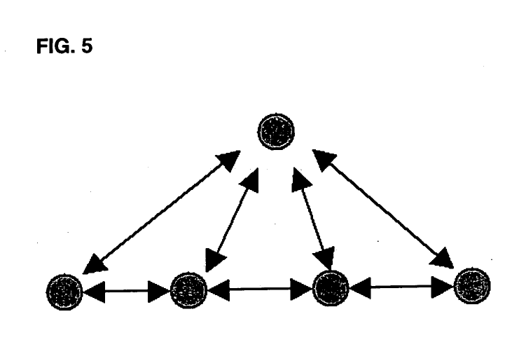

The link graphs between the individual URLs of a compound document tend to contain common “traces” that are indicative of navigational trails through the document. Thus if one sees a link structure of the form shown in FIG. 5 (a typically-bidirectional “wheel”) then one might expect that the top (“hub”) URL is a table of contents and the others are individual sections with links to the previous and next sections.

Analysis of Identified Compound Documents

Once a compound document is identified, the invention employs several techniques that identify a “leader” or a preferred “entry point” that is suitable to present to a user as a representative URL within the document. In this respect, the invention techniques are based on optimizing one (or both) of the following criteria or objectives:
Provide an entry point that is representative in content, or that is a good starting point to follow the flow of a document (such as the first slide in a slide show).
Provide an entry point that is “central” within the document in the sense that it acts as a hub within the document, providing short paths along internal links to most, if not all, of the parts of the document (such as a table of contents for a document).

The invention includes the following techniques developed for heuristically finding such entry points (these techniques all assume a directory has already been identified as a compound document beforehand):

By convention, certain file names (such as index.html, index.htm, index.shtml and default.asp) are often fetched by a web server when a request for a directory without a filename is processed. Such files, if they exist within the directory, are usually designed by the author to be natural entry points to the compound document. Therefore, if such files exist they make for good candidates to be considered as leaders.

In many compound documents, navigation links within the document tend to point to the entry point to the document. For example, in many manuals or other online multi-page documents a “TOC” link is present on every page. This would result with the table of content page (a good leader according to the second criterion we use) having a very high in-degree when only links within the directory are considered.

When people link to a document from outside the document, they will usually provide a link to a good “entry point page” (according to at least one of the two criteria we consider). Therefore, a page within the directory into which many external (out of directory) pages point is a good candidate to serve as a “leader” or entry-point.

Pages within the compound document that point to many other pages within the directory (i.e., have large out-degree when only internal links are considered) would many times be good leader pages, since they tend to satisfy the second criterion we use: they are “hubs”, providing easy navigation to many parts of the document.

The invention can directly try to optimize a second criterion: the vector of distances along intra-document links between a specific page and all other pages of the compound document. Finding the node for which this vector has minimal norm translated directly into the optimization problem defined in the second criterion above. We may similarly generalize the second technique presented above, by finding the node with the minimal norm for its one-to-all distance vector, when distances are taken with the links reversed. This has the effect of locating a node to which there is easy access from all other nodes of the compound document.

A further heuristic that is useful in identifying leaders is to consider the various dates of pages within the same site that point to a page within the compound document. Web servers and filesystems often maintain date information about the content they hold, including the last-modified date, an expiration date, and a creation date. Web servers expose these dates through the HTTP response header, and file servers expose these through a variety of means. Because compound documents are often produced all at once, they tend to have nearly the same last-modified or creation dates. This does not in itself form strong enough evidence that a set of URLs form a compound document, but when a collection of documents is suspected of forming a compound document, the similarity of last-modified dates can provide statistical evidence to confirm it. Further, when a compound document is first placed on a web site, a link will generally be made from some page on the site to the leader of the compound document. Thus the oldest page on the site that links to a URL in the compound document is more likely to point to the leader of the compound document.

Identifying Documents via Leaders

While the main motivation for identifying leaders is to provide a good entry point to an already identified compound document, the existence of a very prominent leader among the set of pages within a directory is also a sign of that collection of pages being a compound document. Naturally, only some of the methods of identifying leaders presented work well in this setting: For instance, the existence of a node with high out-degree of internal links is typically not statistically significant for the identification of compound documents. However, the existence of a node into which almost all external links enter is a good indication that the directory is a compound document. In this context, the invention considers down links, across links and external links to identify the leader and the compound document. These types of links are typically created to allow navigation into the compound document, rather than to allow navigation within the document.

Experimental Results

In all the various data sets we have used, we implemented a preprocessing cleaning phase that was run before our actual experiments. Specifically, we do the following:
1. All URLs that have an HTTP return code of 400 or greater are filtered out.
2. All “fragment” and “argument” parts of links (the parts of a URL that follow a # or a ?symbol) are removed.
3. All self-loops are removed.
4. All links that point to URLs that end in a “non-crawled” extension (a fixed list of extensions that typically do not contain textual content, such as .jpg, .gif, etc.) are removed.
5. All redirects within a directory are resolved.
6. Repeat steps 1 through 3 (this is required as the resolution of redirects may introduce new self-loops).

We have also chosen to ignore certain directories as a whole. First, we ignore directories that have fewer than three pages or more than 250 pages. We have also found that many of the directories we looked at were directory listings automatically generated by the Apache™ web server. Most of those are random collections of files, and do not qualify as compound documents. Therefore, we look for the URLs typically generated by the Apache™ web server for those listings, and ignore directories where these URLs are present.

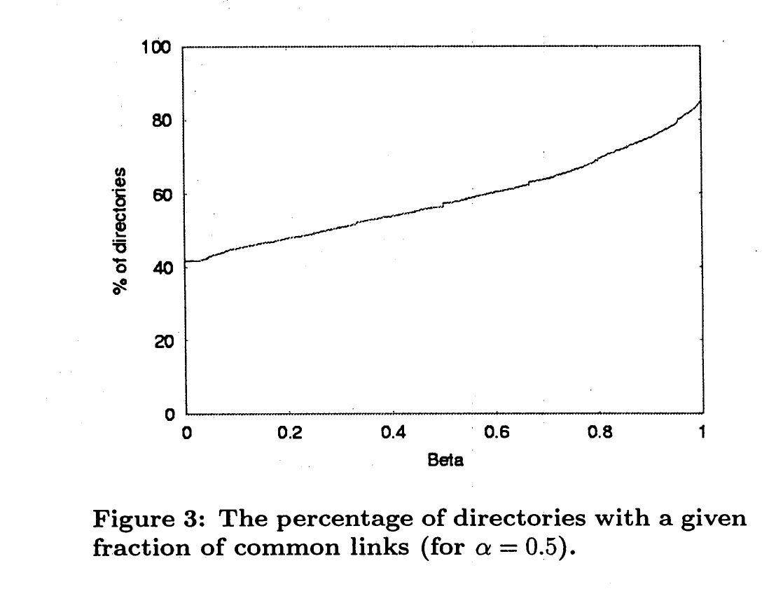

We experimented with various values for the tunable parameters in the two main heuristics. For the rare link heuristic, we used α=0.5, meaning that a link is rare if it appears in less than half the pages. FIG. 3 shows the number of directories that have a certain value of β, for α=0.5 (this graph was generated for a subset of about a tenth of the test corpus, and does not include directories that were ignored because they failed the “cleanup” tests). From the graph it can be seen that the heuristic is relatively insensitive to the actual choice of β. For the bulk of the experiments we set β=0.75.

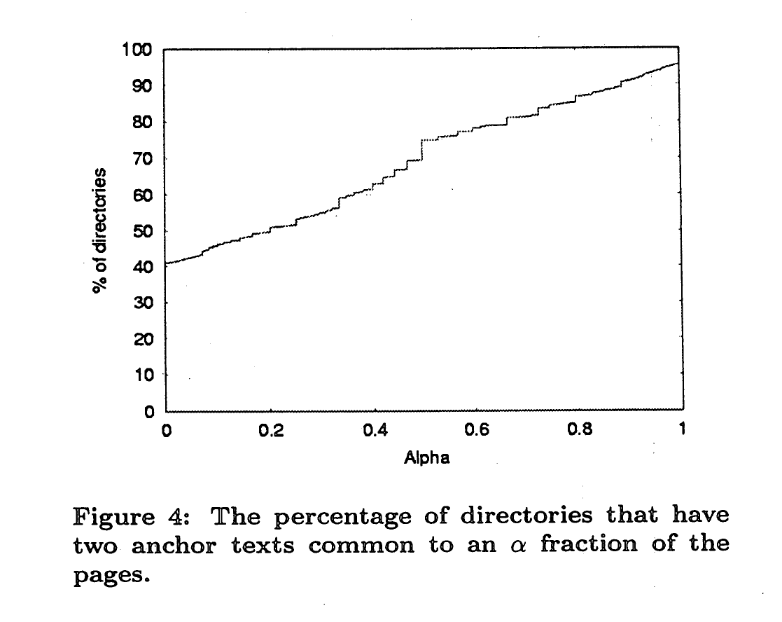

For the common anchor text heuristic, FIG. 4 shows the number of directories that have a certain value of a on a subset of the corpus. The graph shows that the heuristic is relatively insensitive to the choice of a provided it is bigger than 0.5. We have used α=0.8 in our experiments.

In order to validate the results, we manually tagged a small collection of random directories from our 50,000 host Internet crawl. In all, we manually examined 226 directories that passed the automatic screening process described earlier. Of these, 184 were determined to match our subjective definition of a compound document, and 42 were determined not to fulfill the requirements of a compound document. As can be seen in the table below, the heuristics tend to have very few false-positive errors. The numbers shown represent the number of directories identified as compound documents by the various methods.

| | Compound | Non- |
|---|---|---|
| | set | compound set |
| Rare Link | 82 | 4 |
| Anchortext | 28 | 2 |
| Either | 86 | 6 |
| Total size | 184 | 42 |

We manually examined the falsely flagged directories, and have found them to belong to one of two categories. Some of them are what could be called “navigational gateways”. They are a collection of heavily linked hypertext, with very little actual content, that is used to organize a more complex hierarchy of documents. The other type is simply “skeleton” documents, i.e., documents caught in the process of construction and that do not yet have any content to make them fit the definition of compound document, while already having the link structure typical of compound documents.

User Interface Design

The heuristics that have been identified provide very reliable mechanisms for identifying compound documents and their leaders. Once compound documents can be identified, there are opportunities to exploit this information in user interfaces of browsers, search engines, and other tools. Text analysis tools such as search engines tend to have fairly simple user interfaces that present their results in a list format. A notable exception to this rule is Kartoo, which uses a fairly sophisticated graphical user interface to show relationships between individual web sites. One of the challenges in designing a good search engine is to present the user with a well organized and prioritized set of documents, along with context-sensitive summaries that show the relevance to the query. This problem is compounded by the need to summarize compound documents. In the case of a document taxonomy or classification system, the problem is fairly simple because a document may simply be recognized by its leader. The situation is somewhat more complicated in displaying the results for compound document hits in a search engine. In this case a query like “blue banana” may lead to a compound document that had hits for each term in different URLs, but they may not appear together in the contents from a single URL. In this case the user should be presented with an interface that makes clear that distinct parts of the compound document contain the different terms, and allow the user to navigate to those parts or to the leader of the compound document. This is similar to the display problem addressed in the Cha-Cha system[6].

Mathematical Models

In recent years there has been considerable activity on devising evolutionary random graph models for the web that explain some its observed features such as indegree distribution of hyperlinks. These models can provide insight into the structure of information on the web for the purposes of classification, ranking, indexing, and clustering. There are several examples of models that are motivated by social factors about how the web evolves. A good example is the notion of “preferential attachment” [14]. The principle here is that when edges are added to the graph, they are done in such a way that preference is given to vertices that already have high indegree (i.e., the rich get richer).

Recent evidence presented in [12] suggests that while the power law distribution is a good fit to the tail of the distribution of indegrees, the head of the distribution is closer to a log-normal. They also propose a model for generating the web that mixes preferential attachment with a uniform attachment rule, and analyze the fit of the distribution that results. Their results seem to suggest that more complicated models of generating pages and hyperlinks will provide a closer fit to the actual data for indegrees and outdegrees.

Some people have also noticed that models of the web fail to produce specific microstructures that are important features of how information is organized on the web. In particular, the family of models presented in [9] seeks to explain the existence of small “communities” of tightly interconnected webpages, while still producing a degree distribution that obeys a power law. Their model augmented preferential attachment with the notion that links are copied from one page to another, and provided an underlying social motivation for this model.

The web is created by a complicated mix of social actions, and a simple model is unlikely to capture all of the features that are present. Moreover, the things that distinguish the web from a random graph are often precisely the features that are most likely to allow exploitation of structure for information retrieval. Unfortunately, none of the existing models have incorporated the hierarchical nature of information on the web into their models, and this overlooks an important fundamental structure that influences many things in the web.

Hierarchical Structure of the Web

One of the most notable features of the web that we have exploited-is the hierarchical nature of information that is organized within web sites and which is reflected in the hierarchical nature of URLs. This is a very striking and important feature that characterizes the way authors organize information on the web, and yet we are unaware of any existing model that predicts the existence of these structures.

Hyperlinks between web pages tend to follow the locality induced by the directory structure. In particular, two pages within the same directory are more likely to have a link between them than two randomly selected pages on the same host. Taking this a bit further, two randomly selected pages on the same host are more likely to have a link between them than two pages selected at random from the web. Models of the web hyperlink graph structure have not previously been designed to reflect this fact, but this structure is crucial to understanding the relationships between individual web pages.

For the example of the IBM intranet, we discovered that links occur with the following approximate frequencies:

| | Percentage of |
|---|---|
| Type of Link | Total Links |
| Outside | 13.2% |
| Across | 63.2% |
| Down | 11.8% |
| Up | 7.4% |
| Internal | 4.3% |

The exact values may differ from one corpus to another, but in any event it is likely the vast majority of links are “across” links, and that the least frequent type of links are internal links. The large number of “across” hyperlinks may be explained by the fact that many web sites are now heavily templatized, with a common look and feel for most pages including a fixed set of hyperlinks to things like the top of the site, a privacy policy, or a search form. Another noticeable feature is that even though IBM has attempted to enforce a common look and feel across the seven thousand machines that make up the IBM intranet, there are still only 13.2% of the links that go across sites. If the company policy were followed to the letter, then every page on the intranet would have a link to the root of the intranet portal. This perhaps explains much of the “small-world” nature of the hyperlink graph [19], since the probability that there will be a link between two pages is strongly correlated to how close they are to each other in the global URL directory hierarchy.

As mathematical models of the web grow more sophisticated over time, they can be expected to incorporate more and more features and provide more accurate predictions on the structure of the web at both the microscopic (e.g., compound documents and communities) and macroscopic (e.g., indegree distributions) scales. Our goal is simply to suggest a direction for future models that will capture the important feature of compound documents.

More accurate models of the web may be constructed by modifying the process for attaching a vertex or edge, in a manner different from what was presented in [12] and [9]. The web graph is an overlay of two separate graph structures that are correlated to each other. One structure is formed from the links between individual web pages. The other structure is a directed forest in which the trees represent web sites and the directed edges represent hierarchical inclusion of URLs within individual web sites. In addition to attaching a single edge or vertex, a further augmentation is an attachment procedure for an entire branch to the URL tree hierarchy. The links within the tree should be chosen as a representative link graph for a compound document, which is to say that the tree that is attached should be chosen from a probability distribution that reflects the local structure that is characteristic of a compound document.

The purpose of such a model is to mimic the way that web sites and collections of documents are typically created, and determine the effect it would have on other properties of the web graph. Web sites typically evolve independently of one another, but documents on a site often do not evolve independent of each other, and a non-negligible fraction of URLs are added in blocks as compound documents.

Metadata Initiatives

We have focused on the problem of identifying compound documents on the web from their hypertext structure. It is perhaps unfortunate that this task is even necessary, because we are essentially trying to recover the author's original intent in publishing their documents. The HTML specification [1] contains a mechanism by which authors may express the relationship between parts of a document, in the form of the link-type attribute of the <A> and <LINK> tags. This construct allows an author to specify within the contents of an HTML document that another document is related to it via one of several fixed relationships. These relationships include “section”, “chapter”, “next”, and “start”. Unfortunately these tags are seldom used (for example, the previously cited paper in Scientific American does not use them, nor does the New York Times web site or the CNN web site). Even when they are present in a document, they often fail to adhere to the standard (e.g., Microsoft Powerpoint™). There are a few document preparation tools (DocBook and Latex2HTML for example) that produce compound documents with link-type attributes that adhere to the HTML 4.01 specification, but the vast majority of compound documents that appear on the web fail to incorporate them.

The encapsulation of retrievable document fragments into cohesive “documents” may be viewed as only one level of a hierarchical organization of information. Below this level, an individual URL within a compound document might have one of the roles identified in the HTML link-type attribute such as “index”, or “chapter” that distinguishes it from other URLs within the document. Above the document layer, one might find document collections, volumes of scientific journals, conference proceedings, daily editions of newspapers, a division of a company, a product, etc. The organization of the hierarchy above this layer to be dependent on the type of site that contains the document, but the notion of a “human readable document” is a fairly universal concept within any such hierarchy. To be sure, not all hypertext will naturally fall into such a hierarchy, but it can be very useful to exploit when it is present.

Conclusions

Compound documents are a widespread phenomenon on the web, and the identification of compound documents holds promise to improve the effectiveness of web text analytics. Our evidence suggests that approximately 25% of all URLs are in fact part of a compound document. Among all directories, approximately 10% can be identified as containing a compound document. These numbers will grow in the future as more technologies are developed to exploit the power of hypertext.

We have identified several very effective heuristics that can identify such compound documents, including hyperlink graph structures, anchortext similarities, and the hierarchical structure of URLs that are used to reflect computer filesystems. These techniques can be used to bootstrap the construction of a semantic web infrastructure, and point the way to widespread availability of semantic information to identify documents.

A general purpose computer is programmed according to the inventive steps herein. The invention can also be embodied as an article of manufacture—a machine component—that is used by a digital processing apparatus to execute the present logic. This invention is realized in a critical machine component that causes a digital processing apparatus to perform the inventive method steps herein. The invention may be embodied by a computer program that is executed by a processor within a computer as a series of computer-executable instructions. These instructions may reside, for example, in RAM of a computer or on a hard drive or optical drive of the computer, or the instructions may be stored on a DASD array, magnetic tape, electronic read-only memory, or other appropriate data storage device.

While the particular scheme for a SYSTEM, METHOD, AND COMPUTER PROGRAM PRODUCT FOR IDENTIFYING MULTI-PAGE DOCUMENTS IN HYPERTEXT COLLECTIONS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for”.

### References

[1] HTML 4.01 specification, W3C recommendation, December 1999.
[2] Lada A. Adamic and Eytan Adar. Friends and neighbors on the web. http://www.hpl.hp.con/shl/people/eytan/fnn.pdf.
[3] Tim Berners-Lee, James Hendler, and Ora Lassila. The semantic web. Scientific American, May 2001, http://www.sciarn.com/2001/0501issue/OSOlberners-lee.html
[4] Rodrigo A. Botafogo and Ben Shneiderman. Identifying aggregates in hypertext structures. In UK Conference on Hypertext, pages 63-74, 1991.
[5] Vannevar Bush. As we may think. The Atlantic Monthly, 176(1): 101-108, July 1945.
[6] Michael Chen, Marti A. Hearst, Jason Hong, and James Lin. Cha-cha: A system for organizing intranet search results. In USENIX Symposium on Internet Technologies and Systems, 1999.
[7] R. C. Daley and P. G. Neumann. A general-purpose file system for secondary storage. In AFIPS Conference Proceedings, volume 27, pages 213-229, 1965.
[8] M. M. Kessler. Bibliographic coupling between scientific papers. American Documentation, 14, 1963.
[9] S. Ravi Kumar, Prabhakar Raghavan, Sridhar Rajagopalan, and Andrew Tomkins. Extracting large-scale knowledge bases from the Web. In Proceedings of the 25th VLDB Conference, pages 639-650, 1999.
[10] Yoshiaki Mizuuchi and Keishi Tajima. Finding context paths for Web pages. In Proceedings of Hypertext 99, pages 13-22, Darmstadt, Germany, 1999.
[11] Theodor Holm Nelson. Embedded markup considered harmful. http://www.xml.com/pub/a/w3j/s3.nelson.html, October 1997.
[12] David M. Pennock, Gary W. Flake, Steve Lawrence, Eric J. Glover, and C. Les Giles. Winners don't take all: Characterizing the competition for links on the web. Proceedings of the National Academy of Science, 99(8):5207-5211, Apr. 16, 2002.
[13] Craig Silverstein, Monika Henzinger, Hannes Marais, and Michael Moricz. Analysis of a very large altavista query log. Technical report, DEC Systems Research Center, 1998, Technical note 1998-14.
[14] H. A. Simon. On a class of skew distribution functions. Biometrika, 42(3/4):425-440, 1955.
[15] H. G. Small. Co-citation in the scientific literature: A new measure of the relationship between two documents. Journal of American Society for Information Science, 24(4):265-269, 1973.
[16] Ellen Spertus. Parasite: Mining structural information on the web. In Proceedings of the Sixth Internation Conference on the World Wide Web, volume 29 of Computer Networks, pages 1205-1215, 1997.
[17] Amanda Spink, Dietmar Wolfram, B. J. Jansen, and Tefko Saracevic. Searching the web: The public and their queries. Journal of the American Society for Information Science, 53(2):226-234, 2001.
[18] Keishi Tajima, Kenji Hatano, Takeshi Matsukura, Ryouichi Sano, and Katsumi Tanaka. Discovery and retrieval of logical information units in web. In Proceedings of the Workshop on Organizing Wep Space (WOWS 99), pages 13-23, Berkeley, CA, August 1999.
[19] Duncan J. Watts and Steven H. Strogatz. Collective dynamics of “small-world networks”. Nature, 393:440-442, Jun. 4, 1998.
[20] Ron Weiss, Bienvenido Velez, Mark A. Sheldon, Chanathip Namprempre, Peter Szilagyi, Andrzej Duda, and David K. Gifford. Hypursuit: A hierarchical network search engine that exploits content-link hypertext clustering. In ACM Conference on Hypertext, pages 180-193, Washington USA, 1996.
[21] Nadav Eiron, Kevin McCurley. Locality, Hierarchy, and Bidirectionality in the Web, http://www.almaden.ibm.com/cs/people/mccurley/pdfs/graph.pdf
[22] Gary Flake, Steve Lawrence, C. Lee Giles. Efficient Identification of Web Communities, Proceedings of the Sixth International Conference on Knowledge Discovery and Data Mining (ACM SIGKDD-2000), p. 150-160, Aug. 20-23, 2000, Boston, Mass., USA.
[23] Keishi Tajima, Yoshiaki Mizuuchi, Masatsugu Kitagawa, Katsumi Tanaka. Cut as a Querying Unit for WWW, Netnews, and E-Mail, Proc. Of ACM Hypertext '98, June 1998, Pittsburgh, Pa., USA.
[24] Ravi Kumar, Prabhakar Raghavan, Sridhar Rajagopalan, Andrew Tomkins. Trawling the web for emerging cyber-communities, Computer Networks, v. 31, n. 11-16, p.1481-1493, 1999, Amsterdam, Netherlands.
[25] Xiaofeng He, Chris H.Q. Ding, Hongyuan Zha, Horst D. Simon. Automatic Topic Identification Using Webpage Clustering, ICDM 2001, Proceedings IEEE Conference on Data Mining, 2001, p.195-202.
[26] Donna Bergmark. Models and tools for generating digital libraries: Collection synthesis, Proceedings of the second ACM/IEEE-CS joint conference on Digital libraries, July 2002, p.253-262.
[27] Activity analysis of real world entities by combining dynamic information sources and real world entities, Research Disclosure, n. 433100, May 2000, p.905-906.
[28] Virtual URLs for Browsing and Searching Large Information Spaces, Research Disclosure, n. 41392, September 1998, p.1238-1239.
[29] Database for Navigational Links for a Text Part in a Compound Document, IBM Technical Disclosure Bulletin, v. 38, n. 1, January 1995, p. 371-372.
[30] Lada A. Adamic. The Small World Web, Proc. 3^{rd} European Conf. Research and Advanced Technology for Digital Libraries (ECDL), n. 1696, 1999, p.443-452, Springer-Verlag, S. Abiteboul and A.-M Vercoustre eds.

1. A method for improving information retrieval, classification, indexing, and summarization, comprising:
identifying a compound document as a coherent body of hyperlinked material on a single topic as created by a number of collaborating authors;
analyzing the content and structure of the compound document to find a preferred entry point for the compound document;
processing the compound document as a whole, including at least one of indexing, classification, and retrieval; and
processing the compound document from the entry point, including at least one of creating at least one of presentation of results from retrieval, summarization, and classification.

2. The method of claim 1 wherein the body of hyperliked material includes at least one of: the internet, an intranet, and a digital library.

3. The method of claim 1 wherein the body of hyperlinked material is distributed over a plurality of URLs.

4. The method of claim 1 wherein the identifying includes observing the results of a number of heuristics run on the body of hyperlinked material and related hyperlinks.

5. The method of claim 4 wherein the heuristic includes identifying hyperlinks that link within the same directory and include a sufficient quantity of common anchor text.

6. The method of claim 4 wherein the heuristic includes identifying hyperlinks that contain linguistic structures that indicate relationships between parts of a document including at least one of a list of page numbers, and the terms “next”, “previous”, “index”, “contents”, and their non-English equivalents.

7. The method of claim 4 wherein the heuristic includes identifying external hyperlinks to the same places.

8. The method of claim 4 wherein the heuristic includes identifying at least one of: similar creation dates and similar last-modified dates.

9. The method of claim 4 wherein the heuristic includes identifying individual URLs having similar structure indicating an order of inclusion in the compound document.

10. The method of claim 4 wherein the heuristic includes identifying a link structure of “wheel” form.

11. The method of claim 1 wherein the analyzing includes observing the results of a number of heuristics run on the component document and related hyperlinks.

12. The method of claim 11 wherein the heuristic includes identifying specific filenames that define the entry point, including at least one of: “index” and “default”.

13. The method of claim 11 wherein the heuristic includes identifying a particular component document in the compound document as the entry point because the component document has several in-links.

14. The method of claim 13 wherein the in-links are from outside the compound document.

15. The method of claim 11 wherein the heuristic includes identifying a particular component document in the compound document as the entry point because the component document has several out-links.

16. The method of claim 11 wherein the heuristic includes determining a measure of vector distances along intra-document links between a particular component document and all other component documents in the compound document.

17. The method of claim 11 wherein the heuristic includes determining whether a URL has links pointing to longer URLs having common directory components followed by different ending directory components.

18. The method of claim 17 wherein the ending directory components contain specific identifying information.

19. The method of claim 11 wherein the analyzing includes combining the results of a number of heuristics run on various component documents in the compound document, wherein the results include numerical scores and the combining includes a weighted averaging of the numerical scores into an overall score, and the maximum overall score determines the preferred entry point.

20. A system for improving information retrieval, indexing, and summarization comprising:
a compound document identifier that detects a coherent body of hyperlinked material on a single topic as created by a number of collaborating authors;
an analyzer that finds a preferred entry point for the compound document according to the content and structure of the compound document; and
a compound document processor that performs at least one of indexing, classification, and retrieval, for the compound document as a whole, and then performs at least one of creating at least one presentation of results from retrieval, summarization, and classification.

21. A computer program product instantiated on a computer-readable medium, comprising:
a first code means for identifying a compound document as a coherent body of hyperlinked material on a single topic as created by a number of collaborating authors;
a second code means for analyzing the content and structure of the compound document to find a preferred entry point for the compound document; and
a third code means for processing the compound document, wherein the processing includes at least one of creating at least one presentation of results from retrieval, summarization, and classification.
